(19) United States
(12) Patent Application Publication
(10) Pub. No.: US 2011/0069702 A1
(43) Pub. Date: Mar. 24, 2011

(54) BRANDED VOIP SERVICE PORTAL

(75) Inventors: Oguz Oktay, San Jose, CA (US); Melissa Johnson, Los Gatos, CA (US)

(73) Assignee: ARGELA-USA, Santa Clara, CA (US)

(21) Appl. No.: 12/888,048

(22) Filed: Sep. 22, 2010

Related U.S. Application Data
(60) Provisional application No. 61/272,414, filed on Sep. 22, 2009.

(51) Int. Cl. H04L 12/66

(52) U.S. Cl. 370/352

(57) ABSTRACT

A method is provided for a Voice over IP (VoIP) Operator to enable another entity, the call branding company, to offer a phone service of its own brand using that VoIP service company's physical service infrastructure which includes, for example, the VoIP client application, the VoIP network elements, and provisioning, billing and ordering systems, the method including the steps of receiving an incoming VoIP call over a network from a caller's VoIP client, matching one or more parameters of the incoming call against one or more call branding activation triggers; and, in the event of a match, applying call branding to the VoIP call as specified by a call branding configuration profile associated with the matched call branding activation trigger. Additional methods of applying call branding provided include the call branding company setting up a call branding configuration profile with the VoIP service provider, the call branding configuration profile including one or more call branding activation triggers, advertisements, VoIP soft-phone client skins, VoIP service options, sponsorship details and call redirection/forwarding rules.

### BACKGROUND OF THE INVENTION

1. Field of Invention

The present invention relates to a system and method suitable for definition and real-time delivery of customized VoIP service of a call branding company (CBC) by enabling the definition of the VoIP client characteristics, and the selection of phone service capabilities, service handover triggers and campaign parameters such as advertisement insertion capabilities, and in particular to a system and method used to enable a new kind of subsidized VoIP service through a call branding company's advertisement sponsorship and call branding model using a VoIP service provider's network infrastructure.

2. Discussion of Related Art

Voice over Internet Protocol (VoIP) is a general term for a family of transmission technologies for delivery of voice communications over Internet protocol (IP) networks such as the Internet, private IP networks or other packet-switched networks. Other terms frequently encountered and synonymous with VoIP are IP telephony, Internet telephony or broadband phone.

VoIP nowadays refers to a host of communications services, not just voice, such as facsimile, voice messaging, simple messaging service (SMS) and multimedia messaging service (MMS) that are all transported via the Internet, rather than the public switched telephone network (PSTN). The basic steps involved in originating an Internet telephone voice call are conversion of the analog voice signal to digital format and compression/translation of the signal into IP packets for transmission over the Internet; the process is reversed at the receiving end. A VoIP call may originate at a VoIP client and terminate at another VoIP client or simply on a regular phone attached to the PSTN. If it is terminated to a regular phone, then the VoIP service provider interconnects to the network of a PSTN service provider, using a media gateway, which can terminate the call. If the VoIP service involves a messaging service (such as instant message, SMS or MMS), the message content is generated in digital format, carried over the Internet and delivered to the recipient in digital form.

VoIP networks employ session initiation protocol (SIP) carried over IP to control the set-up and tear-down of calls as well as audio/video codecs which encode speech/video allowing transmission over an IP network as digital audio via an audio/video stream. SIP is used for signaling between the client application and SIP proxy (server) and between VoIP switches in the network. VoIP networks may employ many other IP protocols in addition to SIP such as RTP, RTSP, and RTCP to carry media (speech and/or video), DIAMETER and RADIUS for billing and AAA functions, and MGCP and MEGACO for media gateway control. Such protocols are defined by Internet Engineering Task Force (IETF). Also, many different standards are available for audio and video codecs which are developed by the standard body called ITU-T.

VoIP has extended its footprint from wireline networks to mobile networks through IP Multimedia Subsystem (IMS) which merges Internet technologies with the mobile world, using a pure VoIP infrastructure. IMS enables mobile service providers to upgrade their existing systems while embracing Internet technologies such as the Web, email, instant messaging, presence, and video conferencing. With IMS, all VoIP services will be carried on a mobile handset. The “Dual mode” telephone sets, which allow for the seamless handover between a cellular network and a Wi-Fi network, are expected to help VoIP become even more popular.

The VoIP telephony interface is usually a SIP client application which can be located on a computer such as the PC or on a mobile handset through which the user can make or receive phone calls. Skype™ is a popular VoIP application which uses a client application as the user interface. The user may have a phone number or simply an ‘alias’ or name for voice services. Alternatively, the SIP client application may reside hidden in a ‘box’ which in turn attaches to a phone handset. The user will make and receive calls using the phone handset emulating a PSTN based regular phone service. Vonage™ is another popular VoIP application where the user uses a phone handset and a phone number in contrast to Skype service where the user uses a VoIP software application (Skype application). Some VoIP services such as Tuitalk are one way only. With Tuitalk, users can make calls from their PCs to a PSTN or mobile phone numbers, but cannot be called back. Doing so, Tuitalk does not use and manage phone numbers for their users.

In parallel to the rapid evolution of phone service from PSTN to VoIP, from voice to multimedia, from ‘black-phone’ to ‘soft-phone’, there is a constant pressure to lower the price of voice calls. As a consequence, the service providers suffer from significant Average Revenue Per Unit (ARPU) drops as they try to compete fiercely on price. The overwhelming growth in Skype's business has been attributed, among others, to “free-calling” phenomena between two Skype users.

The “free-calling” model can only survive in the long run when another entity subsidizes calls through advertising. Video advertising has been evolving from TV advertising to Internet advertising. Recently, with the advent of Broadband Internet access, and web and streaming technologies, on-line web-based video advertising started getting significant momentum. Particularly, in-banner and in-stream type of video and image-based advertising are used on web pages while users search for content or purchase goods on the Internet. Although video advertisement is available on the web, it is not as effective as television advertisement since the audience is not “captive” (i.e., the viewer may simply skip watching the video by closing the video window and proceeding with the task in hand). Advertising through telecommunication channels is a relatively new area. It offers to companies a direct marketing possibility.

Different than the common traditional advertisement channels (newspapers, TV, radio, billboards, etc), telecommunication channels provide the added benefits of direct marketing advantage as the end-user can be classified in terms of age, gender, level of income, location, etc. Taking advantage of these two evolutions, sponsoring a call through advertisement will definitely open up a new and controlled channel for advertisements. With the edging technologies, it is possible to push video based commercials to the end-users just as in TV advertisements.

With advertisement sponsored calling (or in short ‘sponsored calling’), a sponsor's advertisement plays before, during or at the end of the call causing a lower cost or free calling for the called Party. In a sponsored call offering, the sponsoring company provides one or more audio, video or text advertisements, and user profiles and business rules according to which service provider shall insert these advertisements into user's calls (i.e., insert ad-x when the called party matches a certain user profile, or insert ad-y according to a business rule such as ‘to all in-state callers’). The notion of sponsored calling in PSTN and VoIP networks is well known.

The concept of ‘call branding’ is an extension of the concept of ‘advertisement sponsored calling’. Prior art also describes call branding associated PSTN services. For example, call branding in the PSTN associated with the calling or called party is achieved by assigning a special number (800, 900 or other) so that a branded announcement or advertisement is played during the call (e.g., welcome to Turkish Airlines). Additionally, the calling and called parties can have special interactions through an Interactive Voice Recognition (IVR) system. Even different tariffs (e.g., free calling to 800 numbers) and/or payment options (e.g., reverse billing for 900 numbers) apply.

### SUMMARY OF THE INVENTION

In one embodiment, the present invention provides a method for a VoIP service provider to provide call branding of a VoIP call, the method comprising the steps of receiving an incoming VoIP call over a network from a caller's VoIP client, matching one or more parameters of the incoming call against one or more call branding activation triggers, and in the event of a match, applying call branding to the VoIP call as specified by a call branding configuration profile associated with the matched call branding activation trigger.

In an extended embodiment, one or more of the following call parameters of the incoming VoIP call, such as the number of the called party, the caller's user ID, the caller's geographic location and the caller's VoIP client type is matched against the call branding activation triggers specified by one or more Call Branding Companies in determining whether call branding should be applied to the received call.

In one specific embodiment, the call branding applied to a VoIP call comprises modifying the appearance of the caller's VoIP soft-phone client, including changing a logo displayed by the VoIP client soft-phone; applying a skin to the VoIP client soft-phone; modifying an existing skin on the VoIP client soft-phone; and adding or removing a functional component of the VoIP client soft-phone, such as a video call panel, an audio call panel, a chat panel and an SMS panel.

In another embodiment, call branding takes the form of one or more advertisements, such as video, audio, and banner advertisements that are provided to the caller before, during, or upon completion of the VoIP call. The advertisements provided may be specified in a call branding configuration profile.

In yet another embodiment, call branding comprises modifying the VoIP service options available to the caller, such as allowing local calls only, enabling calls to mobile numbers, allowing all calls including long distance or international calls, or allowing calls to one or more pre-specified numbers only.

In another specific embodiment, call branding comprises providing a level of sponsorship of the VoIP call, such as by providing a number of free call minutes, a reduced rate per minute, free long distance, free SMS messages or by providing free calls.

In another embodiment, call branding is provided by opening a pre-specified web page in the caller's web browser, displaying a “Call Me” button that dials a pre-specified number when the caller clicks the button, or by redirecting/forwarding a call to a pre-specified number during or upon completion of the VoIP call originally dialed.

In another embodiment, the present invention provides a method for a VoIP service provider to provide call branding of a VoIP call, the method comprising the steps of inputting, by a third party, a call brand activation trigger and an associated call brand configuration profile, receiving an incoming VoIP call over a network from a caller's VoIP client, matching one or more parameters of the incoming call against one or more call branding activation triggers, and, in the event of a match, applying call branding to the VoIP call as specified by the call branding configuration profile associated with the matched call branding activation trigger wherein providing call branding of the incoming call comprises one or more of the following: modifying the appearance of a VoIP client soft-phone; providing one or more advertisements to the VoIP client soft-phone; modifying VoIP service options; providing sponsorship of the VoIP call by the third party; and forwarding a call to a pre-specified number after the termination of a call originally dialed.

In a third, specific embodiment, the present invention provides a method for a VoIP service provider to provide call branding of a VoIP call, the method comprising the steps of inputting, by a third party, a call brand activation trigger and an associated call brand configuration profile, receiving an incoming VoIP call over a network from a caller's VoIP client, matching one or more parameters of the incoming call against one or more call branding activation triggers, and, in the event of a match, applying call branding to the VoIP call by applying a skin to a VoIP client soft-phone as specified by the call branding configuration profile associated with the matched call branding activation trigger.

### BRIEF DESCRIPTION OF THE DRAWINGS

FIG. 1 illustrates an exemplary description of Branded Service Creation Software (BSCS) connecting many Call Branding Companies (CBCs) to VoIP service provider's service infrastructure.

FIG. 2 illustrates an exemplary description of BSCS controlling VoIP service provider's service by attaching to SIP Service Logic (SSLO)

FIG. 3 illustrates an exemplary high-level system component diagram of BSCS and SSLO.

FIG. 4 illustrates a method for a new CBC configuring its branded calling service with BSCS.

FIG. 5 illustrates a method for a user making a branded call using a CBC's configurations.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

In this invention, we describe branded service creation software (BSCS) application for the VoIP service provider so that they can offer a branded call service over their VoIP services. With BSCS, the VoIP service provider can offer to a new entity called the call branding company (CBC) a total freedom to re-design a VoIP service (voice or multimedia) reflecting their brand, in return sponsoring the user's call through advertisement. The call branding company's service runs on the VoIP service provider's service infrastructure. By doing so, the CBC emulates a VoIP service provider without having any component of the physical network and service infrastructure of a service provider. The handover from VoIP service provider's native service to CBC's branded service occurs when a call branding activation trigger (CBRAT) is received before or during a call.

The branded call offering has four parties:
VoIP service provider
Call Branding Company (CBC)
Calling Party
Called Party

According to this invention, the VoIP service provider allows a CBC to define all parameters of the call to an extent that the call branding company can play special advertisements, define calling service options, apply different service tariffs and payment options, and even provide special interactions (e.g., redirect the calling party to a call-me option or to a web-site) during (or after) a call between a Calling and Called Party. In essence, the calling and/or the called party perceives the CBC as the service provider as opposed to the VoIP service provider for a specific call(s). Although more primitive forms of the branding notion exists as a service offering such as ‘Sponsored Call’ in prior art in which a voice call is partially or fully paid by a sponsoring company in exchange for playing an advertisement announcement before, during or after the call, there are no other controls in sponsored call over the phone service.

The soft-phone client is a software application capable of showing a multimedia advertisement using audio and video codecs, and provides capabilities to show text and banners. The user can also initiate a phone call through a soft-phone client. The soft-phone client provides TV-like multimedia capabilities to view recorded videos of sponsors. For example, Tuitalk is a VoIP service that is totally sponsored by video and banner advertisement. While making phone calls, users are provided with capabilities so that they can interact with the advertiser while viewing the ad, divert the call, ask for a reminder at the end of call, and/or ask for information in the form of an SMS to the mobile phone of the user. The soft-phone client can be embedded on a mobile phone or a PDA or it can be downloaded onto a PC or a handheld from a web site, or alternatively, it can be integrated to a web browser.

With the CBC concept of this invention, a special CBRAT allows the VoIP call to be handed over by the VoIP service provider to the CBC's call definitions and desired soft-phone client capabilities. For example, when a Calling Party calls a local car dealer, the service provider notices the dealer's number as a CBRAT, and redefines the call according to a car company's (the CBC) call definitions. If the call is a VoIP call using a client application on a PC or handset, the skin of the VoIP client application is transformed to a car-company-defined client application appearance and capabilities. Another CBC may elect to integrate its services as a ‘special campaign’ over the VoIP service provider's service. For example, the VoIP service provider may link it's offering to the CBC's offering as follows: ‘if you are a frequent caller to Country-ABC, downloads the client of ZZ-airline company and use this client to make calls and to get 5 minutes free for each call to Country-ABC’. When the user goes to the VoIP service provider's web page, downloads the ZZ-airlines' VoIP soft-phone client, and uses this special client, called the branded service client (BSC), the calls to ABC will become ZZ sponsored. Note that the CBRAT in this instance is the ‘frequent calling to Country ABC’. Every time a user makes a call using the BSC, the user shall be informed of the CBC's products or services or new promotions. Users/customers can also use the BSC to make free calls to CBC's call center to get customer service or purchase additional products or services (e.g., reserving airline tickets).

The branded VoIP service concept brings a lucrative and completely new business model for the VoIP service provider. Through this service, many CBCs simultaneously become the customer of the VoIP service provider. These CBCs may have to compete against one another to grab the largest user base corresponding to a specific activation trigger, which enables the VoIP service provider to price its service to CBCs accordingly. Thus, whoever wants the first priority for a specific activation trigger pays more money to the VoIP service provider.

The BSCS software application of this invention enables the definition and instant activation of the VoIP service branded by the CBC by providing the configuration and provisioning of the SIP-based service logic in many areas including:
CBRAT
   User profile based rules
   Specific business rules
   Wild-card (general) rules
Soft-phone client appearance options (e.g., changes to logo, color palette, fonts, individual client application components, client page orders, etc.)
VoIP service options (e.g., domestic or international calls only, no call forwarding, SMS support, etc.)
Advertisement options:
   Placement location (e.g., before, during and after the call)
   Advertisement media types (e.g., video, audio, banner)
   Advertisement content
Sponsorship options (e.g., totally free call, free 5 minutes, reduced rate per minute, free SMS, free long distance)
Call redirect options (e.g., an optional “Call-Me” button appears on the screen, or call terminates at the web site of Honda Motors). Redirection comes after the actual call or after the user intentionally clicks on “Call-Me” button.
Billing options (e.g., reverse billing, pre-pay or post-pay)
Reporting Options (e.g., specify how the CBC receives reports on number of sponsored calls, number of advertisement clicks, sponsored minutes, etc.)

Systems and methods consistent with the present invention provides a new business model through which many call branding companies (CBCs) can share a VoIP service provider's network simultaneously and may enjoy offering telephone service that is CBC-branded and completely or partially subsidized by their advertisements. The VoIP service provider provides telecommunications and Internet infrastructure to make multimedia calls as well as the operations infrastructure to provision, activate and bill the service.

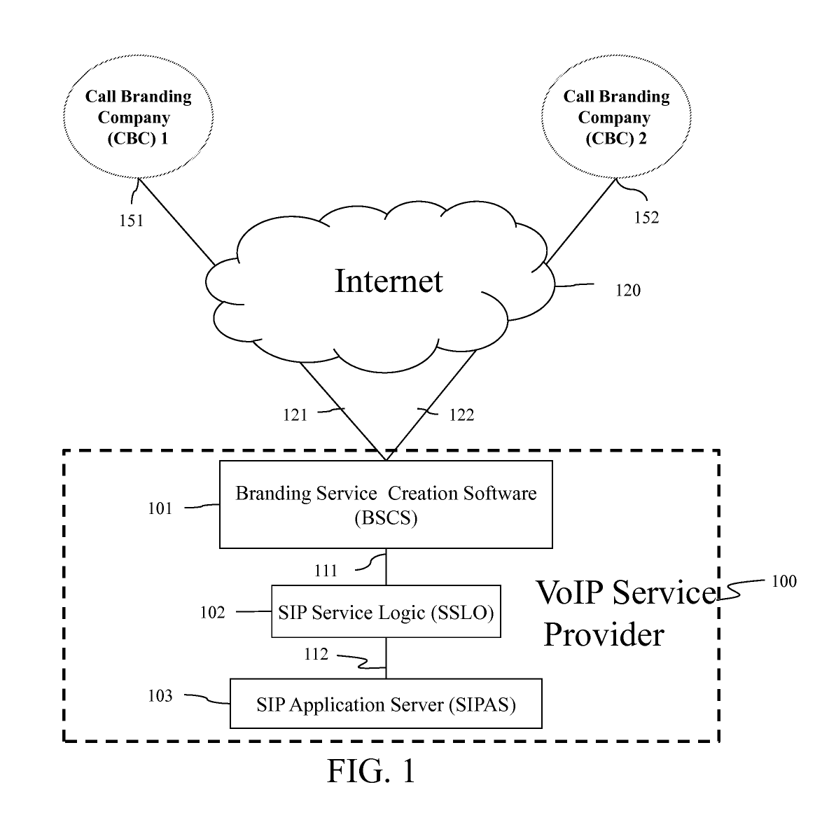

As described above, BSCS 101 resides in the VoIP service provider's network 100 and simultaneously serves one or more CBCs 151 and 152, as shown in FIG. 1. As such, BSCS 101 connects to the Internet 120 to simultaneously attach and serve multiple CBCs. BSCS 101 may be located within the VoIP service provider's telecommunications or operations network, in one of its data (hosting) centers, or in a different location. BSCS 101 can be implemented in a single server or it can be distributed to several servers.

The VoIP service provider connects to CBCs 151 and 152 through TCP/IP links 121 and 122 over Internet 120, respectively. Depending on the software application of BSCS, these links may have different IP protocols. For example, if BSCS 101 is a web-application, then these links will carry HTTP protocol. BSCS 101 attaches to SIP Service Logic (SSLO) 102 through link 111. SSLO 102 in turn attaches to SIP Application Server (SIPAS) 103 through link 112. The BSCS, SSLO and SIPAS may run on the same server or different servers. If the BSCS, SSLO and SIPAS run on the same server, links 111 and 112 will simply be inter-processor or inter-application connectivity. On the other hand, if the BSCS, SSLO and SIPAS run on different computers, but are collocated, links 111 and 112 will simply be LAN connections using protocols such as Ethernet. If the BSCS, SSLO and SIPAS run on different computers, and are spread out to different data centers of the VoIP service provider, links 111 and 112 may be private network lines or IP connectivity over the Internet.

SIP Application Server (SIPAS) 103 is an off-the-shelf product from vendors such as Avaya™, HP®, and Oracle®, which provides real-time SIP call control functions. SIPAS 103 provides a simple API based interface (such as Java™ based SIP JSR or JAIN API) towards the service logic implementations such as SSLO 102 so that the service logic can be executed in real-time as a call proceeds. The APIs simplify the implementation of specific service logic. Capabilities such as inserting an advertisement during a call, or restricting the call to domestic numbers, or giving a specific number of free minutes are all call control functions that are executed through the SSLO. SSLO 102 provides call-control markers during the call where certain CBC features can be inserted easily. These features are configured and activated in the SSLO through BSCS 101.

With SIPAS 103, the VoIP service provider creates intelligent, dynamic SIP applications that can initiate, screen, route, transfer, and bill SIP VoIP calls—including functionality of SIP redirect, proxy, and Back-to-Back User Agent (B2BUA) applications.

BSCS 101 of FIG. 1 is used by the CBCs 151 and 152 to enter the CBCs' selected branding options, in the form of a call branding configuration profile, which includes many call control capabilities as well as other configurable or provisionable capabilities that entail soft-phone client look and feel, billing, and advertisement related information. BSCS 101 in turn configures SSLO 102 which in turn populates several databases.

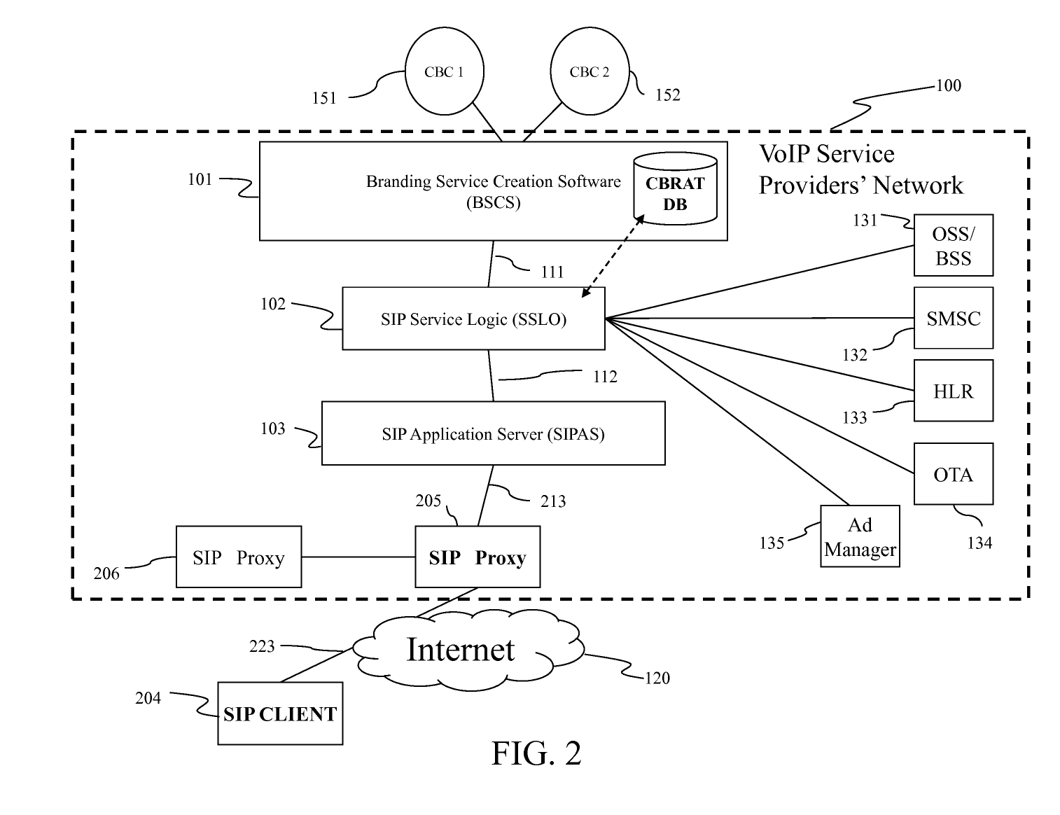

FIG. 2 shows additional components of the system. SIP Client 204 represents the soft-phone client on a user's PC or handset where a branded call is initiated. SIP Client 204 connects to VoIP service provider's access SIP Proxy 205 through link 223, which is carried over the Internet. This link carries SIP signaling (aka call control) messages, and other protocols such as RTP, RTCP, etc., to the actual call content such as speech and video.

The call is first intercepted at the operator's network by access SIP Proxy 205, which routes the SIP signaling to SIPAS 103 for handling of call control. SIPAS 103 in turn sends the SIP messages to SSLO 102. The SSLO checks with the CBRAT database of BSCS 101 to determine if there is a matching activation trigger for the call (e.g., matching user profile or matching called number). If there is a match with a CBC's CBRAT, then the call is to be processed as that CBC's call, and the SSLO starts executing the service logic programmed in the SSLO by the BSCS for that CBC. If there is no matching CBRAT, then the call is processed as the VoIP service provider's call in which case SIP Proxy 205 routes the call signaling to the next SIP proxy on the route, which is SIP Proxy 206 in FIG. 2. While SSLO 102 processes the call control according to CBC's rules, it may need to communicate with other systems such as OSS/BSS 131 for billing, SMSC 132 for text messaging, and advertisement manager 135 for handling of advertisement insertion. If the VoIP service provider is a mobile operator, then there may be communications with HLR/HSS 133 for user location information and OTA 134 for over-the-air capabilities services.

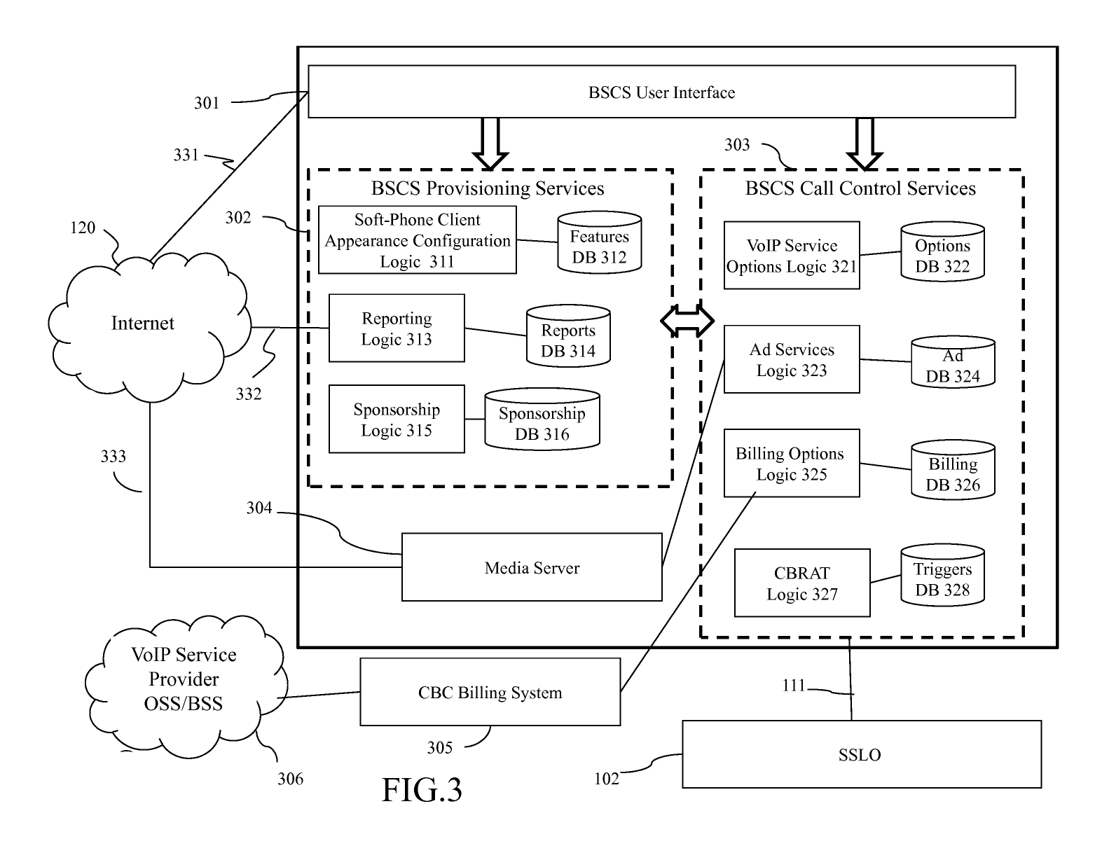

A block diagram of an exemplary embodiment of BSCS 101 is shown in FIG. 3. The BSCS is comprised of the following sub blocks:
1. BSCS User Interface 301: This interface is connected to Internet 120 by link 331, and is exposed to each CBC so that they can easily configure a call branding configuration profile defining their branded service. The interface may be a web-portal to which each CBC can access securely, or it could be a downloadable software application provided to each CBC by the VoIP service provider.
2. BSCS Provisioning Services Logic 302: Upon a CBC's configuration of a call branding configuration profile of a new branded service or changes to a call branding configuration profile of an existing branded service using BSCS User Interface 301, the services that require one-time provisioning and configuration are executed in this software component. It has three major functions. First, soft-phone client appearance configuration logic 311 configures the soft-phone client appearance as specified according to the requirements of the CBC. In addition to the soft-phone client appearance configuration logic, BSCS Provisioning Services Logic 302 includes features database 312, which contains all configuration parameters and features of the soft-phone client. The user-downloadable version of the CBC soft-phone client is produced by this logic. Second, reporting logic 313 delivers reports to the CBC on the branded service. These reports may show billing (such as settlement) information of the VoIP service provider, usage reports and reports on user-clicks on ads. The reporting options are stored in reports database 314 associated with the reporting logic. The reporting logic is provided with link 332 to Internet 120 for the delivery of reports to the CBCs. Third, sponsorship logic 315 delivers a certain level of sponsorship to the user. The sponsorship may be in the form of some free-minutes or reduced rate per minute. Sponsorship logic 315 has an associated database 316 that contains each CBC's sponsorship parameters.
3. BSCS Call Control Logic 303: This function is different than BSCS Provisioning Services Logic 302 as it interacts with the call control in real-time, meaning all the changes to call control are handled through BSCS Call Control Logic 303 and SSLO 102 which interacts with the BSCS Call Control Logic in real time. BSCS Call Control Logic 303 has several sub functions. First, VoIP services options logic 321 defines what services are allowed for the CBC's user in accordance with service options specified and stored in associated database 322. Second, advertisement services logic 323 selects an advertisement for the user and triggers the delivery of the advertisement by sending the advertisement's content, stored in associated database 324, to media server 304. Third, billing services logic 325 handles the call control logic if the CBC's service is a pre-paid service (e.g. counting down minutes), in accordance with billing configuration and options stored in associated database 326. This software component interacts with CBC Billing System 305. Fourth, CBRAT logic 327 detects triggering of a CBC's service during call setup according to the triggers specified for activation of a CBC's service stored in associated triggers database 328.
4. Media Server 304: This software component may be off the shelf. Its sole purpose is to send down advertisements to the user during the call using streaming technology.
5. CBC Billing System 305: This software component is the billing system specially designed for CBC users. The CBC Billing System may be part of VoIP service provider's OSS/BSS infrastructure 306 or, alternatively, it may be a separate system, as shown in FIG. 3, specifically allocated to CBC calls that attaches to VoIP service provider's OSS/BSS infrastructure 306.

Note that advertisement services logic 323 governs how advertisements are fed to the user over the Internet. Media Server 304 is a type of streaming server known in prior art to send stored video to streaming clients (such a Microsoft® and Real Network® media players) for viewing. It can be controlled through protocols such as SIP and Media Gateway Control Protocol (MGCP) defined by standard bodies. Media Server 304 attaches to Internet 120 by link 333.

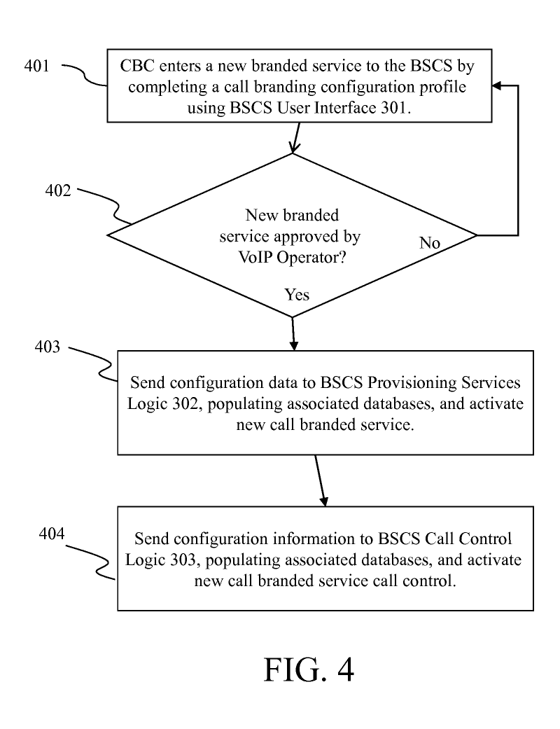

FIG. 4 shows a method for a CBC to define a call branding configuration profile for a new branded service using the BSCS. At step 401, the CBC accesses the VoIP service provider's BSCS system using the BSCS User Interface 301. The BSCS User Interface guides the CBC to make choices related to its branded service options (such as service options, sponsorship amounts, etc.), to input configuration information such as multimedia advertisement content, company logos and other soft-phone client related graphics, and to input other important configuration information such as activation trigger rules. The VoIP service provider checks to determine if the configuration information entered by the CBC is complete and accurate at step 402. If the configuration information entered by the CBC is approved, the system proceeds to populate other BSCS functions. If the configuration information is not approved, the CBC must re-enter the data that is wrong or incomplete. After approval, at step 403, the information from the call branding configuration profile entered through the BSCS User Interface is pushed into BSCS Provisioning Services Logic 302. The information is used to populate the various databases associated with the BSCS Provisioning Services Logic. BSCS Call Control Logic 303 is configured by the information from the call branding configuration profile entered through the BSCS User Interface in step 404. The information is used to populate the various databases associated with the BSCS Call Control Logic. Upon completion, the VoIP service provider is ready to offer the CBC-branded service.

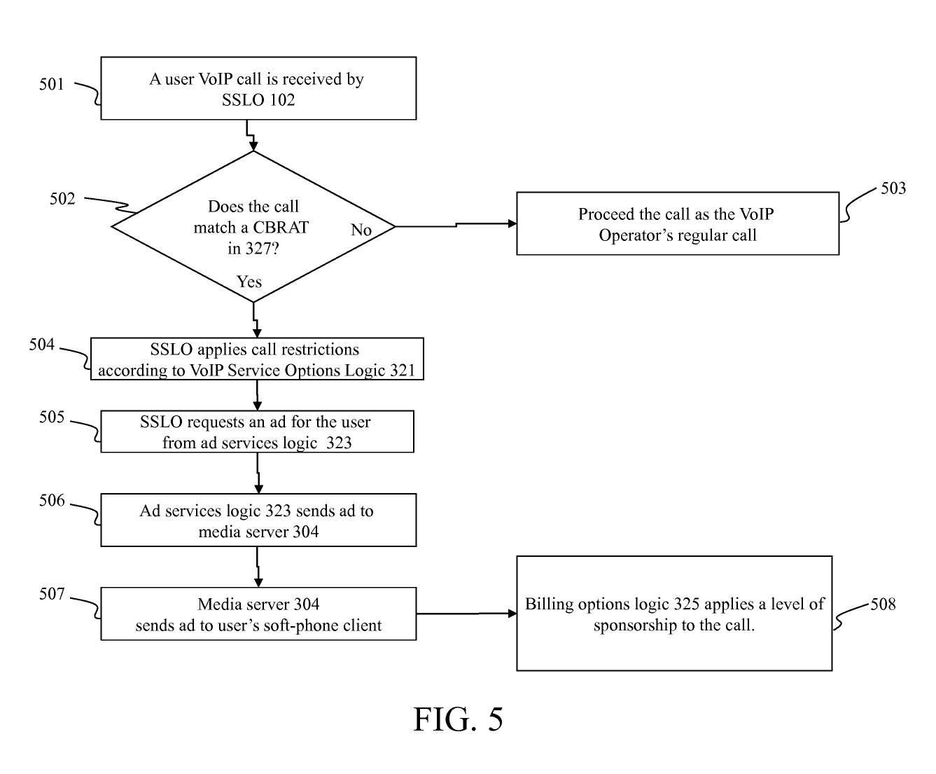

FIG. 5 illustrates a method of providing call branding to a call. In step 501, a user makes a VoIP call that is received by SSLO 101. In step 502, the SSLO examines the parameters of the call and determines whether the parameters match any CBC-specified CBRATs using CBRAT Logic 327 and associated database 328. If the call parameters do not match any CBRATs, then the call proceeds as the VoIP service provider's call in step 503. If there is a matching CBRAT, SSLO interacts with VoIP service options logic 321 to apply any applicable call restrictions in step 504. SSLO then sends a request to advertisement services logic 323 to fetch the appropriate advertisement(s) for the user in step 505. The advertisement services logic sends the selected advertisement(s) to media server 304 in step 506, which in turn delivers the advertisement(s) to the user's CBC branded soft-phone client in step 507. Media server 304 also supports video control functions from client such as fast forward, stop and resume. When the advertisement is completed, SSLO 102 triggers a charging and settlement function in step 508 by communicating with billing options logic 325, which may connect to CBC Billing System 305. The billing options logic 325 applies a level of sponsorship to the call according to sponsorship logic 315. In parallel, the SSLO also triggers the call control function to perform regular call signaling towards the VoIP service provider for call completion.

### CONCLUSION

A system and method has been shown in the above embodiments suitable for definition and real-time delivery of customized VoIP service of a call branding company (CBC) by enabling the definition of the VoIP client characteristics, and the selection of phone service capabilities, service handover triggers and campaign parameters such as advertisement insertion capabilities, and in particular to a system and method used to enable a new kind of subsidized VoIP service through a call branding company's advertisement sponsorship and call branding model using a VoIP service provider's network infrastructure. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A method for a VoIP service provider to provide call branding of a VoIP call, the method comprising the following steps:
receiving an incoming VoIP call over a network from a caller's VoIP client;
matching one or more parameters of the incoming call against one or more call branding activation triggers; and
in the event of a match, applying call branding to the VoIP call as specified by a call branding configuration profile associated with the matched call branding activation trigger.

2. The method of claim 1, wherein the parameter to be matched against one or more call branding activation triggers is one of the following: number of the called party; caller's user ID; VoIP client type; and geographic location of the calling party.

3. The method of claim 1, wherein the call branding activation trigger and the associated call branding configuration profile are specified by a third party.

4. The method of claim 1, wherein applying call branding to the VoIP call comprises modifying the appearance of a VoIP soft-phone client.

5. The method of claim 4, wherein modifying the appearance of a VoIP soft-phone client comprises one of the following: changing a logo displayed by the VoIP soft-phone client; applying a skin to the VoIP soft-phone client; modifying an existing skin on the VoIP soft-phone client; and adding or removing a functional component of the VoIP soft-phone client.

6. The method of claim 5, wherein the functional components of the VoIP soft-phone client comprise one of the following: an SMS panel; a chat panel; a video call panel; and an audio call panel.

7. The method of claim 1, wherein applying call branding to the VoIP call comprises providing one or more advertisements to a VoIP soft-phone client.

8. The method of claim 7, wherein providing one or more advertisements to a VoIP soft-phone client comprises providing one or more advertisements at one or more of the following times: before the call; after the call; and during the call.

9. The method of claim 7, wherein providing one or more advertisements to a VoIP soft-phone client comprises providing one or more of the following: a video advertisement; an audio advertisement; and a banner advertisement.

10. The method of claim 7, wherein providing one or more advertisements to a VoIP soft-phone client comprises providing one or more specific advertisements as indicated by the call branding configuration profile.

11. The method of claim 1, wherein applying call branding to the VoIP call comprises opening a pre-specified web page in an Internet browser.

12. The method of claim 1, wherein applying call branding to the VoIP call comprises displaying a “Call Me” button that dials a pre-specified number when clicked by the user.

13. The method of claim 1, wherein applying call branding to the VoIP call comprises forwarding a call to a pre-specified number after the termination of a call originally dialed.

14. The method of claim 1, wherein applying call branding to the VoIP call comprises modifying VoIP service options.

15. The method of claim 14, wherein VoIP service options include one of the following: allowing local calls only; allowing calls to mobile numbers; allowing long distance calls or international calls; and allowing calls to pre-specified numbers only.

16. The method of claim 1, wherein applying call branding to the VoIP call comprises providing sponsorship of the VoIP call by a third party.

17. The method of claim 16, wherein providing sponsorship of the VoIP call comprises one of the following: providing a number of free VoIP call minutes; providing a reduced rate per minute; completely subsidizing the cost of a VoIP call; providing free long distance or international calls; and providing free SMS messages.

18. A method for a VoIP service provider to provide call branding of a VoIP call, the method comprising the following steps:
inputting, by a third party, a call brand activation trigger and an associated call brand configuration profile;
receiving an incoming VoIP call over a network from a caller's VoIP client;
matching one or more parameters of the incoming call against one or more call branding activation triggers; and
in the event of a match, applying call branding to the VoIP call as specified by the call branding configuration profile associated with the matched call branding activation trigger;
wherein providing call branding of the incoming call comprises one or more of the following: modifying the appearance of a VoIP soft-phone client; providing one or more advertisements to the VoIP soft-phone client; modifying VoIP service options; providing sponsorship of the VoIP call by the third party; and forwarding a call to a pre-specified number after the termination of a call originally dialed.

19. A method for a VoIP service provider to provide call branding of a VoIP call, the method comprising the following steps:
inputting, by a third party, a call brand activation trigger and an associated call brand configuration profile;
receiving an incoming VoIP call over a network from a caller's VoIP client;
matching one or more parameters of the incoming call against one or more call branding activation triggers; and
in the event of a match, applying call branding to the VoIP call by applying a skin to a VoIP soft-phone client as specified by the call branding configuration profile associated with the matched call branding activation trigger.
